(19) United States
(12) Patent Application Publication
(10) Pub. No.: US 2011/0250879 A1
(43) Pub. Date: Oct. 13, 2011

(54) WIRELESS COMMUNICATION SYSTEM FOR A LEVEL

(76) Inventor: Ryoji Miyahara, Nagasaki (JP)

(21) Appl. No.: 12/443,751

(22) PCT Filed: Jun. 1, 2007
(86) PCT No.: PCT/JP2007/061212

§ 371 Date: Nov. 16, 2009

(30) Foreign Application Priority Data
Oct. 2, 2006 (JP) 2006-270522

(51) Int. Cl. H04W 4/00; H04B 17/00

(52) U.S. Cl. 455/422.1; 455/67.11

(57) ABSTRACT

[Problems to be Solved] In view of the problem of known wireless communication systems for a level, it is an object of the present invention to provide a wireless system that can operate both for individual communications and simultaneous communications.

[Means for Solving Problems] A wireless communication system for a level according to the present invention characterized in that the system comprises a central monitoring unit, mobile stations operating as moving object wireless terminals, and an underground base station, and that the central monitoring unit can selectively operate either in a simultaneous talk mode of talking to all the mobile stations through the underground base station or in an individual talk mode of selecting a specific mobile station based on the mobile station identification information so as to talk to the selected mobile station through the underground base station.

### TECHNICAL FIELD

This invention relates to a wireless communication system for a level or a gallery that makes persons in an underground structure such as a coal mine or a road tunnel and persons outside the structure able to communicate with each other.

### BACKGROUND ART

It is a common practice for works in coal mines and road tunnels that persons in an underground structure and persons outside the structure communicate with each other for safety checks and other operations by some communication means.

### DISCLOSURE OF THE INVENTION

### Problem to Be Solved by the Invention

Wireless communications and PHS communications are popular means for such communications. However, the PHS is only for individual talks so that it is difficult to send information to all the PHS sets in an underground structure simultaneously or talk to all the persons in the underground structure simultaneously in an emergency.

On the other hand, a wireless communication allows a terminal to send information to all the other terminals of the system so as to be received by all the other terminals simultaneously. However, a wireless communication terminal cannot talk to some other terminal individually.

In view of the above-identified problem of known wireless communication systems for a level, it is therefore an object of the present invention to provide a wireless system that can operate both for individual communications and simultaneous communications.

### Means for Solving the Problem

According to the present invention, the above object is achieved by providing a wireless communication system for a level characterized in

that the system comprises:

a central monitoring unit arranged outside an underground structure;

mobile stations operating as moving object wireless terminals; and

at least an underground base station arranged in a management area of the underground structure, and

that each of the mobile stations is made to store specific mobile station identification information and the central monitoring unit can selectively operate either in a simultaneous talk mode of talking to all the mobile stations through the underground base station or in an individual talk mode of selecting a specific mobile station based on the mobile station identification information so as to talk to the selected mobile station through the underground base station.

Preferably, a wireless communication system for a level according to the invention is characterized in that, if necessary, the central monitoring unit is equipped with a relay unit and can operate in a relay talk mode, when the central monitoring unit receives relay talk request information from a predetermined mobile station for talking to another mobile station identified by the mobile station identification information of the latter mobile station, it allows the predetermined mobile station to talk to the latter mobile station through the relay unit.

Additionally, preferably, a wireless communication system for a level according to the present invention is characterized in that the central monitoring unit and the base station send information to and receive information from each other by wired communications and the base station and the mobile stations send information to and receive information from each other by wireless communications.

### ADVANTAGES OF THE INVENTION

Thus, a wireless communication system for a level according to claim 1 of the present invention is characterized in that the system comprises a central monitoring unit arranged outside an underground structure, mobile stations operating as moving object wireless terminals and at least an underground base station arranged in a management area of the underground structure and that each of the mobile stations is made to store specific mobile station identification information and the central monitoring unit can selectively operate either in a simultaneous talk mode of talking to all the mobile stations through the underground base station or in an individual talk mode of selecting a specific mobile station so as to talk to the selected mobile station through the underground base station. Therefore, the central monitoring unit arranged outside an underground structure can communicate with mobile stations located in the underground structure simultaneously or with any of the mobile stations individually.

Preferably, a wireless communication system for a level according to claim 2 of the present invention is characterized in that, if necessary, the central monitoring unit is equipped with a relay unit and can operate in a relay talk mode, when the central monitoring unit receives relay talk request information from a predetermined mobile station for talking to another mobile station identified by the mobile station identification information of the latter mobile station, it allows the predetermined mobile station to talk to the latter mobile station through the relay unit. Thus, mobile stations can talk to each other whenever necessary.

Still preferably, a wireless communication system for a level according to claim 3 of the present invention is characterized in that the central monitoring unit and the base station send information to and receive information from each other by wired communications and the base station and the mobile stations send information to and receive information from each other by wireless communications. Thus, the central monitoring unit can reliably talk to any of the mobile stations through the base station if the underground structure is a complicated structure.

### BRIEF DESCRIPTION OF THE DRAWINGS

FIG. 1 is a schematic block diagram of an embodiment of wireless communication system for a level according to the present invention, showing the configuration thereof.

FIG. 2 is a schematic block diagram of an underground base station 20, showing the internal configuration thereof.

FIG. 3 is a schematic block diagram of a mobile station 30, showing the internal configuration thereof.

FIG. 4 is an example of arrangement of base stations in an underground structure.

### BEST MODE FOR CARRYING OUT THE INVENTION

Now, a wireless communication system for a level or a gallery according to the present invention will be described in greater detail by referring to the accompanying drawings that illustrate an embodiment of the invention.

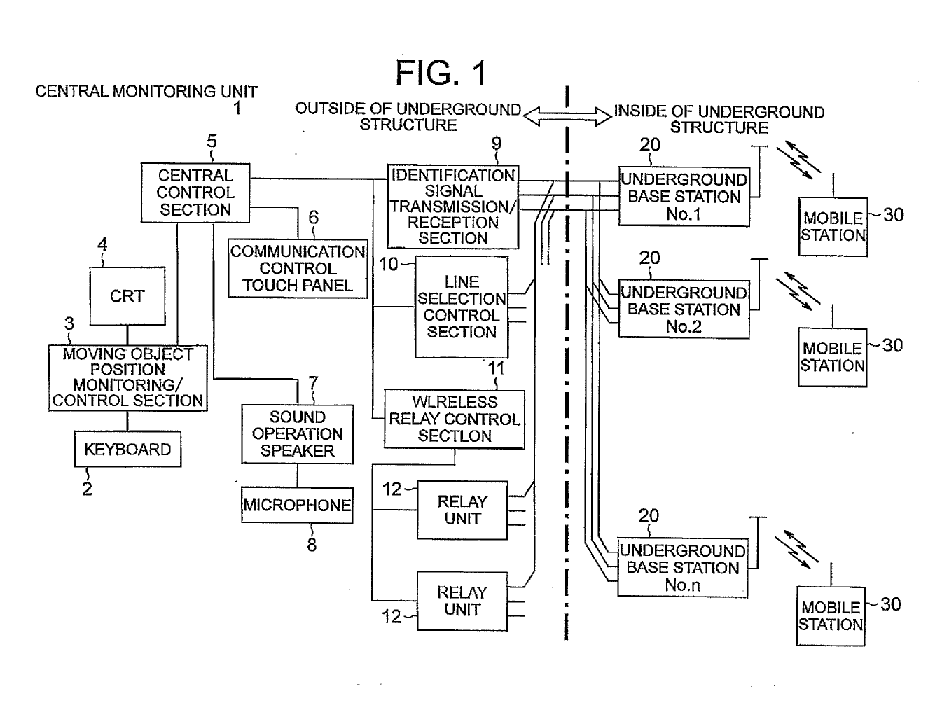

FIG. 1 is a schematic block diagram of an embodiment of wireless communication system for a level according to the present invention, showing the configuration thereof.

As shown, the wireless communication system for a level has:

a central monitoring unit 1 arranged outside an underground structure;

n base stations 20 arranged in the underground structure: and

mobile stations 30 to be carried respectively by workers.

The central monitoring unit 1 outside the underground structure and each of the base stations 20 in the underground structure are connected to each other by an appropriate cable for wired communications so that they can send information to and receive information from each other through the cable.

On the other hand, each of the base stations 20 and each of the mobile stations 30 in the underground structure can send information to and receive information from each other wirelessly.

As shown in FIG. 1, the central monitoring unit 1 includes a keyboard 2, a moving object position monitoring/control section 3, a monitor 4, a central control section 5, a communication control touch panel 6, a sound operation speaker 7, a microphone 8, an identification signal transmission/reception section 9, a line selection control section 10, a wireless relay control section 11 and a plurality of relay units 12.

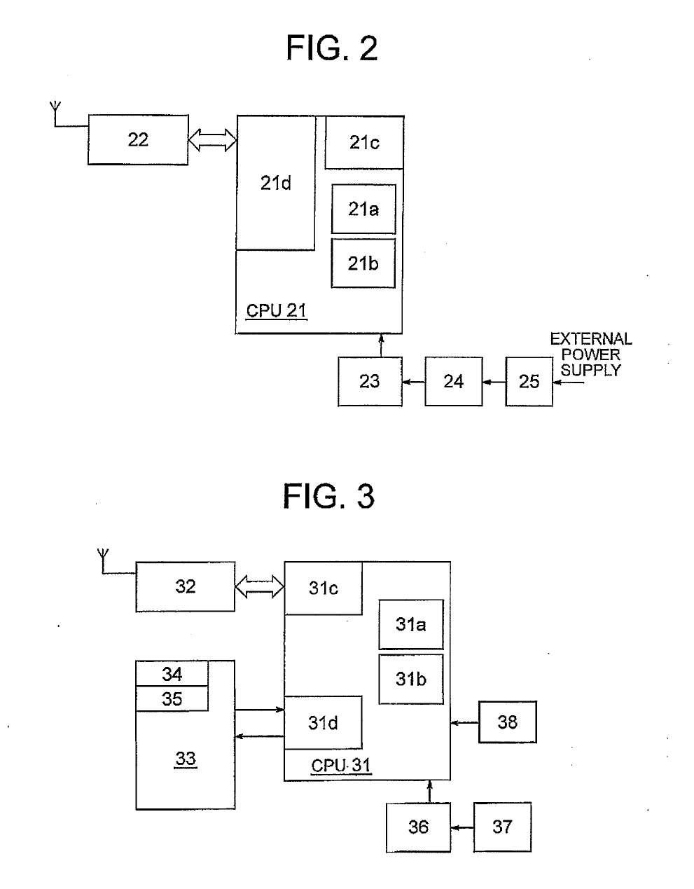

FIG. 2 is a schematic block diagram of an underground base station 20, showing the internal configuration thereof.

The underground base station 20 includes:

an 8-bit CPU 21;

a unique format wireless transmitter/receiver set 22 for wirelessly communicating with each of the mobile stations D at 800 MHz with a unique format; and

a power supply having a regulator 23, a nickel-cadmium battery 24 and a charging circuit 25.

The CPU 21 by turn includes a built-in flash ROM 21a, a built-in RAM 21b, a wired interface 21c for connecting the base station 20 to the central monitoring unit 1 and a wireless interface 21d for the wireless transmitter/receiver set 22.

The built-in flash ROM 21a of the base station 40 stores in advance the base station identification number assigned to each of the base stations.

The base stations 20 are connected to each other by optical cables. Preferably, however, the base stations 20 are connected to each other not in series but by branch connections or the optical cables are duplicated so that the trouble of any of the underground base stations 20 may not adversely affect the communications of the remaining base stations 20.

FIG. 3 is a schematic block diagram of a mobile station 30 to be carried by a worker entering the underground structure, showing the internal configuration thereof.

The mobile station 30 includes:

an 8-bit CPU 31;

a unique format wireless transmitter/receiver set 32 for wirelessly communicating with each of the other mobile stations D at 800 MHz with a unique format;

a man-machine interface 33 including a microphone and a speaker, a buzzer 34, a switch 35; and

a power supply having a regulator 36 and a lithium-ion battery 37.

The CPU 31 by turn includes a built-in flash ROM 31a, a built-in RAM 31b, a wireless interface 31c for the wireless transmitter/receiver set 32 and a standard input/output port 31d for the man-machine interface 33 and so on.

The built-in flash ROM 31a stores in advance the mobile station identification number assigned to it.

The mobile station 30 additionally includes a gas sensor 38 and, when the gas sensor 38 detects a gas concentration higher than a predefined level, the CPU 31 automatically transmits information on the gas concentration to the corresponding base station 20 along with the own mobile station identification number. With this arrangement, the central monitoring unit 1 can detect early an abnormal condition in the underground structure. For instance, it may be so arranged that, when the CPU 31 receives abnormality information from any of the mobile stations 30, it simultaneously transmits an alarm signal to all the mobile stations 30 through the base stations 20 to improve the safety in the underground structure.

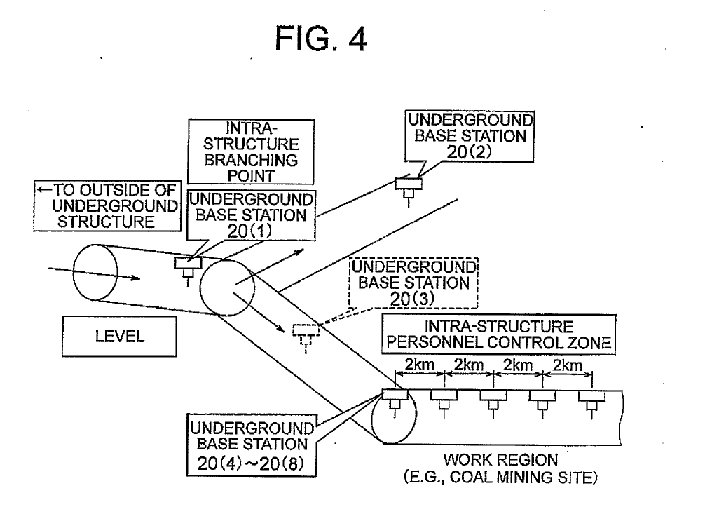

The underground base stations 20 are arranged at predetermined respective positions as shown in FIG. 4.

While the base stations 20 may be arranged so as to cover the entire area of the underground structure, taking the coverage of the antenna of the wireless transmitter/receiver set 22 of each of the base stations 20 into consideration, it is preferable to arrange a base station 20 at each branching point, a base station on each level and a plurality of base stations on each level and each region (to be referred to as work region) where a large number of workers go in and out, the plurality of base stations being arranged at regular intervals, as shown in FIG. 4.

In the instance illustrated in FIG. 4, five underground base stations 20 are arranged at intervals of 2 km, each having a coverage of a radius of 1.2 km, so that a work region of 10 km may be satisfactorily covered.

The central monitoring unit 1 typically operates for polling periodically and records which base station covers which mobile station according to the response signals it receives.

More specifically, the central monitoring unit 1 periodically calls each of the mobile stations 30 by way of the corresponding base station 20. The CPU 31 of the called mobile station 30 automatically transmits its own mobile station identification number stored in its built-in flash ROM 31a as a response signal.

When a base station 20 receives a response signal (mobile station identification number) from a mobile station 30, the CPU 21 of the base station 20 automatically transmits positional information prepared by adding its own base station identification number to the response signal to the central monitoring unit 1.

The moving object position monitoring/control section 3 of the central monitoring unit 1 is so adapted that it stores in a temporal manner the pieces of positional information transmitted from each of the base stations 20 and displays which mobile station 30 is found in the sensing range of which base station 20 in the underground structure.

Additionally, the moving object position monitoring/control section 3 of the central monitoring unit 1 is so adapted that it can update the positional information of each mobile station 30 if it is talking with the mobile station 30 as will be described hereinafter.

Furthermore, the central monitoring unit 1 is adapted to display which mobile station 30 is covered by which base station 20 on the monitor 4. If there is a mobile station 30 whose position is not moved or not operated for a predetermined time period, the central monitoring unit 1 calls the mobile station 30 by means of its polling feature and acquires information on the base station 20 that covers the mobile station 30 so as to, if necessary, update/alter the positional information.

The central monitoring unit 1 and each mobile station 30 can wirelessly communicate with each other by way of an underground base station 20.

Each mobile station 30 can wirelessly communicate with another mobile station 30 through an underground base station 20 under the control of the central monitoring unit 1.

This wireless communication system for a level has talk modes including “a simultaneous talk mode”, “an individual talk mode”, “a call talk mode”, “a relay talk mode” and “an interrupt talk mode”. The communication control touch panel 6 of the central monitoring unit 1 is provided with switches for selecting any of the modes and the switch corresponding to the mode that is selected and currently active is held on, whereas the switches corresponding to all the other modes are held off.

Now, each of the above listed talk modes will be described below.

1. Simultaneous Talk Mode

The central monitoring unit 1 normally operates in a simultaneous talk mode. In other words, the simultaneous talk mode switch is normally held on at the communication control touch panel 6. When the simultaneous talk mode switch is off, the central monitoring unit 1 is switched to a simultaneous talk mode as the switch is touched. Then, the simultaneous talk mode switch is turned on.

In a simultaneous talk mode, the talk information from the central monitoring unit 1 is transmitted with all the base station identification numbers and all the mobile station identification numbers so that all the underground base stations 20 receive the talk information from the central monitoring unit 1 and all the mobile stations 30 receive the talk information from the corresponding base stations 20.

Then, the identification signal transmission/reception section 9 of the central monitoring unit 1 receives the transmissions from all the underground base stations 20 regardless of the base station identification numbers and the mobile station identification numbers and outputs the sounds from all the mobile stations 30 coming through the corresponding base stations 20 that include all the base stations 20.

2. Individual Talk Mode

An individual talk mode is a mode in which a mobile station 30, the sensing area of the base station 20 covering which is known, is called and can talk onto with the central monitoring unit 1.

As the individual talk mode switch is touched, the communication control touch panel 6 of the central monitoring unit 1 turns on the switch, turning off all the other switches, so that the central monitoring unit 1 can call any desired mobile station 30 individually.

As a manager in the central monitoring unit 1 inputs the mobile station identification number of the mobile station 30 that he or she wants to call and the base station identification number whose sensing area covers the mobile station 30 via the keyboard 2 and subsequently touches the individual talk mode switch, the switch is turned on and all the other switches are turned off. Then, an individual talk signal that includes the mobile station identification number and the base station identification number that are input is transmitted to the underground base station having the base station identification number.

The individual talk signal is received by the base station 20 having the base station identification number and the base station 20 that receives the individual talk signal transmits the individual talk signal it receives via the wireless transmitter/receiver set 22

The individual talk signal transmitted from the base station 20 is then received by the mobile station 30 having the mobile station identification number that is found within the sensing area of the base station 20.

As the mobile station 30 that receives the individual talk signal, its buzzer 34 is driven to sound by a control signal contained in the individual talk signal.

Then, as the worker carrying the mobile station 30 pushes the switch 35 of the mobile station 30 and sends the mobile station identification number to the central monitoring unit 1 via the base station 20, the central monitoring unit 1 can talk individually only to the mobile station 30.

3. Call Talk Mode

A call talk mode is a mode in which a mobile station 30, the sensing area of the base station 20 covering which is unknown, is called and can talk onto with the central monitoring unit 1.

As only the mobile station identification number is input and “the call talk mode” switch is touched at the central monitoring unit 1, a call talk signal that includes the mobile station identification number that is input and all the base station identification numbers is transmitted from the central monitoring unit 1 to all the underground base stations 20.

Since the call talk signal includes all the base station identification numbers, it is received by all the underground base stations 20.

Then, as each of the underground base stations 20 receives the call talk signal from the central monitoring unit 1, it transmits a call talk signal that includes the mobile station identification number via its wireless transmitter/receiver set 22.

The signal transmitted from the base stations 20 is received only by the mobile station 30 having the mobile station identification number that is found within the sensing area of one of the base stations 20.

As the mobile station 30 receives the call talk signal, its buzzer 34 is driven to sound by the control signal contained in the individual talk signal.

Then, the worker carrying the mobile station 30 pushes the switch 35 of the mobile station 30 and sends the mobile station identification number to the central monitoring unit 1 via the base station 20.

As the central monitoring unit 1 receives the response information from the base station 30, “the call talk mode” switch is turned on to complete the call.

As “the individual talk mode” switch is pushed after “the call talk mode” switch is turned on, the call talk mode is shifted to an individual talk mode between the mobile station 30 and the central monitoring unit 1. Thus, the mobile station 30 and the central monitoring unit 1 can talk to each other.

4. Relay Talk Mode

A relay talk mode is employed when a mobile station 30 talks to another mobile station 30 that is found within the sensing area of an underground base station 20 other than the underground base station 20 that covers it.

When the worker carrying a mobile station 30 wants to have a relay talk with the worker having some other mobile station, he or she transmits a relay talk request signal that includes the own mobile station identification number from the mobile station 30. Then, the relay talk request signal is transmitted to the central monitoring unit 1 via the corresponding base station 20.

As the central monitoring unit 1 receives the relay talk request signal from the mobile station 30, it connects the underground base stations 20 that cover the respective mobile stations 30 wanting to have a relay talk to the relay unit 12 to automatically relay the talk between the underground base stations 20.

During this operation, the relay talk mode switch is held on at the communication control touch panel 6 of the central monitoring unit 1.

5. Interrupt Talk Mode

When the interrupt talk mode switch is touched at the central monitoring unit 1 while the relay talk mode switch is held on, the interrupt talk mode switch is turned on and the central monitoring unit 1 is connected for a relay talk so that the central monitoring unit 1 can talk to a base station 30 that is currently talking via the two base stations 20 having a relay talk.

As the interrupt talk mode switch is touched once again at the central monitoring unit 1, the switch is turned off and the central monitoring unit 1 is cut off from the relay talk.

6. Return to Simultaneous Talk Mode

As pointed out above, the central monitoring unit 1 normally operates in a simultaneous talk mode and, after an operation in some other mode, it manually or automatically returns to the simultaneous talk mode.

The communication control touch panel 6 operates to manually return the central monitoring unit 1 to the simultaneous talk mode. The central monitoring unit 1 may be so arranged that it automatically returns to the simultaneous talk mode when a predetermined time (1 to 5 minutes) passes after the last talk.

Thus, as described above, the central monitoring unit 1 and each of the base stations 20 are connected to each other by wired communications and the base stations 20 and the mobile stations 30 are connected to each other for wireless communications, the central monitoring unit 1 can reliably talk to any of the mobile stations 30 via a base station 20 if the underground structure is a complicated structure.

While only a single work region is arranged in the underground structure in the above-described instance, any number of work regions may be arranged if necessary.

While five underground base stations 20 are arranged at intervals of 2 km, each having a coverage of a radius of 1.2 km, so that a work region of 10 km may be satisfactorily covered in the above-described instance, the number of underground base stations 20 arranged in an underground structure and the intervals of arrangement of base stations 20 are not limited to those of the above-described instance and may be appropriately selected according to the area of the work region in which base stations are to be arranged and the coverage of each of the base stations to be operated.

While 800 MHz is selected for wireless communications between mobile stations 30 and underground base station 20 to realize satisfactory communications in the underground structure in the above-described instance, the frequency band to be used for wireless communications is by no means limited to that of the above-described instance and any appropriate frequency may be selected according to the topography of the level where the mobile stations are operated.

While an 8-bit CPU is employed for each of the underground base stations 20 and the mobile stations 30 in the above-described instance, the number of bits of the CPU of each of the stations is not limited to that of the above described instance and, for example, a 16-bit or 32-bit CPU may alternatively be employed.

The power supply of each of the base stations and the mobile stations is not limited to that of the above-described instance and any appropriate power supply may alternatively be employed for the purpose of the present invention.

### EXPLANATION OF REFERENCE SYMBOLS

1: central monitoring unit
2: keyboard
3: moving object position monitoring/control section
4: monitor
5: central control section
6: communication control touch panel
7: sound operation speaker
8: microphone
9: identification signal transmission/reception section
10: line selection control section
11: wireless relay control section
12: plurality of relay units
20: base station
21: CPU
21a: built-in flash ROM
21b: built-in RAM
21c: wired interface
21d: wireless interface
22: unique format wireless transmitter/receiver set
23: power supply having a regulator
24: nickel-cadmium battery
25: charging circuit
30: mobile station
31: CPU
31a: built-in flash ROM
31b: built-in RAM
31c: wireless interface
31d: standard input/output port
32: unique format wireless transmitter/receiver set
33: man-machine interface
34: buzzer
35: switch
36: regulator
37: lithium-ion battery
38: gas sensor

1. A wireless communication system for a level characterized in
that the system comprises:
a central monitoring unit arranged outside an underground structure;
mobile stations operating as moving object wireless terminals; and
at least an underground base station arranged in a management area of the underground structure; and
that each of the mobile stations is made to store specific mobile station identification information and the central monitoring unit can selectively operate either in a simultaneous talk mode of talking to all the mobile stations through the underground base station or in an individual talk mode of selecting a specific mobile station based on the mobile station identification information so as to talk to the selected mobile station through the underground base station.

2. The system according to claim 1, characterized in that, if necessary, the central monitoring unit is equipped with a relay unit and can operate in a relay talk mode, when the central monitoring unit receives relay talk request information from a predetermined mobile station for talking to another mobile station identified by the mobile station identification information of the latter mobile station, it allows the predetermined mobile station to talk to the latter mobile station through the relay unit.

3. The system according to claim 1, characterized in that the central monitoring unit and the base station send information to and receive information from each other by wired communications and the base station and the mobile stations send information to and receive information from each other by wireless communications.

4. The system according to claim 2, characterized in that the central monitoring unit and the base station send information to and receive information from each other by wired communications and the base station and the mobile stations send information to and receive information from each other by wireless communications.
